(19) United States
(12) Patent Application Publication
(10) Pub. No.: US 2012/0001937 A1
(43) Pub. Date: Jan. 5, 2012

(54) INFORMATION PROCESSING SYSTEM, INFORMATION PROCESSING APPARATUS, AND INFORMATION PROCESSING METHOD

(75) Inventors: Nobuhiro Tagashira, Nagareyama-shi (JP); Masayuki Homma, Tokyo (JP); Taichi Matsui, Yokohama-shi (JP); Takashi Aso, Yokohama-shi (JP); Kazuya Kishi, Kawasaki-shi (JP)

(73) Assignee: CANON KABUSHIKI KAISHA, Tokyo (JP)

(21) Appl. No.: 13/169,899

(22) Filed: Jun. 27, 2011

(30) Foreign Application Priority Data
Jun. 30, 2010 (JP) 2010-149970

(51) Int. Cl. G09G 5/00

(52) U.S. Cl. 345/629

(57) ABSTRACT

An information processing system includes an information processing apparatus and a display apparatus including an imaging unit. The display apparatus superimposes an image of a first processing apparatus not having a predetermined function, captured by the imaging unit, and an image of a second processing apparatus having the predetermined function to display the superimposed image, and sends an image captured by the imaging unit to the information processing apparatus. The information processing apparatus performs processing for providing the predetermined function, when detecting, from the captured image received from the display apparatus, that a user of the first processing apparatus has performed an operation for using the predetermined function.

### BACKGROUND OF THE INVENTION

1. Field of the Invention

The present invention relates an information processing system, an information processing apparatus, an information processing method, and program.

2. Description of the Related Art

In recent years, for image forming apparatuses such as copying machines, an image processing system has been proposed that has not only a standalone copy function, but also, e.g., a print function for printing data from an external computer equipment by establishing connection with the computer equipment via a network. Moreover, this image processing system has, for example, a send function for converting a document scanned by a scanner in the image forming apparatus to an electronic data file and sending the electronic data file to the external computer equipment via the network.

Recently, the use of a mixed reality system has also been proposed. The mixed reality system presents to a user a well-known mixed reality space obtained by combining a real space and a virtual space.

Camera-equipped head mounted displays (HMDs) are often used as imaging and display apparatuses. In HMDs, an imaging system and a display system are independently provided on the right and left sides to achieve stereoscopic vision based on binocular disparity (parallax).

Japanese Patent Application Laid-Open No. 2005-339266 discusses a technique relating to such a mixed reality system. According to the technique, in a mixed reality system, data, such as CAD data, is placed in a virtual space as a virtual object therein. A video image, obtained by seeing this virtual object from the position of the viewpoint of a camera of an HMD, i.e., in the direction of sight line, is generated. The generated image is displayed on a display apparatus of the HMD. This technique allows the virtual image corresponding to the virtual CAD data to be displayed in a real space video image without overlap with the user's hand.

The main object of the technique discussed in Japanese Patent Application Laid-Open No. 2005-339266 is to generate a virtual space video image based on the sense of vision and to superimpose the virtual object on a real space video image to present a resultant image to the user.

For example, according to the description in Japanese Patent Application Laid-Open No. 2005-339266, when a user views a real space through an HMD, a nonexistent image forming apparatus is superimposed and displayed as a virtual object. The user can operate the user interface (UI) of the virtually displayed image forming apparatus. However, the apparatus actually being used by the user may not have a function corresponding to the operation of the UI. To utilize or use the function that only the other image forming apparatus as the virtual object has, the user needs to operate the apparatus being actually used by the user. Thus, there is no other way but to actually get the product or travel to the place where the product is installed to use the function.

### SUMMARY OF THE INVENTION

The present invention is directed to a technique in which a user can, by looking at an apparatus actually being used by the user through a display apparatus, operate another apparatus that is being virtually displayed, to invoke a desired function of the other apparatus.

According to an aspect of the present invention, an information processing system includes an information processing apparatus and a display apparatus including an imaging unit. The display apparatus superimposes an image of a first processing apparatus not having a predetermined function, captured by the imaging unit, and an image of a second processing apparatus having the predetermined function to display the superimposed image, and sends an image captured by the imaging unit to the information processing apparatus. The information processing apparatus performs processing for providing the predetermined function when detecting, from the captured image received from the display apparatus, that a user of the first processing apparatus has performed an operation for using the predetermined function.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of an image processing system according to an exemplary embodiment of the present invention.

FIG. 2 illustrates an example of a cross-section of a reader unit and a printer unit.

FIG. 3 illustrates an example of an operation unit of a copying apparatus.

FIG. 4 schematically illustrates an example of a structure of an HMD.

FIG. 5 illustrates an example of a video image obtained by superimposing, on an image forming apparatus in a real space, a video image of another image forming apparatus.

FIG. 6 illustrates an example of a hardware configuration of a host computer functioning as a server or a personal computer (PC).

FIG. 7 illustrates an example of a hardware configuration of the HMD.

FIG. 8 is a flowchart illustrating an example of vectorization processing.

FIG. 9 is a flowchart illustrating an example of processing for providing a vector scan function in which the vectorization processing illustrated in FIG. 8 is used.

FIG. 10 illustrates an example of job-combining printing.

FIG. 11 is a flowchart illustrating an example of processing in the server performed to provide a print-job-combining function.

FIG. 12 is a flowchart illustrating an example of processing in the image forming apparatus and the server performed to provide a print-job-combining function.

### DESCRIPTION OF THE EMBODIMENTS

Various exemplary embodiments, features, and aspects of the invention will be described in detail below with reference to the drawings.

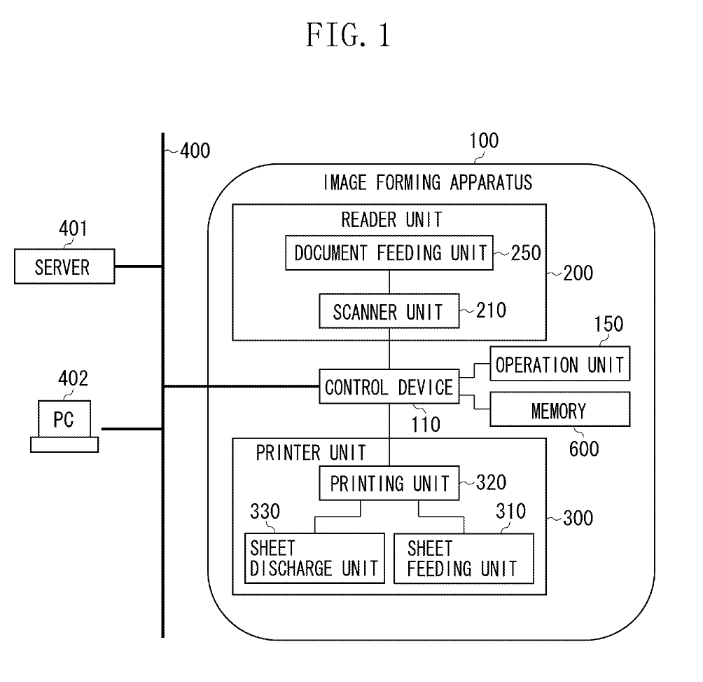

FIG. 1 illustrates an example of the system configuration of an image processing system, which is an example of an information processing system according to an exemplary embodiment of the present invention. A reader unit (an image input apparatus) 200 optically reads document images to convert the read images to image data. The reader unit 200 includes a scanner unit 210 having a function for reading documents, and a document feeding unit 250 having a function for conveying document sheets.

A printer unit (an image output apparatus) 300 conveys recording sheets, prints image data on the recording sheets as visible images, and discharges the printed sheets out of the apparatus. The printer unit 300 includes a sheet feeding unit 310 having multiple types of recording-sheet cassettes, a printing unit 320 having the function of transferring print data to recording sheets and fixing the transferred print data on the recording sheets, and a sheet discharge unit 330 having the function of sorting, stapling, and then discharging printed recording sheets out of the apparatus.

A control device 110 is electrically connected with the reader unit 200, the printer unit 300, and a memory 600. The control device 110 is also connected with a server 401 and a PC 402 via a network 400, and thus can communicate with the server 401 and the PC 402.

The server 401 may be in a separate host computer, or may be in the same host computer as the PC 402. The present exemplary embodiment will be described assuming that the server 401 is in the same host computer as the PC 402. The server 401 is an example of an information processing apparatus. The PC 402 serves as a client that sends print jobs to the image forming apparatus 100, which is an example of an image processing apparatus.

The control device 110 provides a copy function by controlling the reader unit 200 to read print data of a document and controlling the printer unit 300 to output the print data onto a recording sheet. The control device 110 also has a scan function for converting a document read from the reader unit 200 to an electronic data file, and sending the electronic data file to the host computer via the network 400.

The control device 110 further has a printer function for converting PDF data received from the PC 402 via the network 400 to bitmap data and outputting the bitmap data to the printer unit 300. The control device 110 further has a function for storing scanned-in bitmaps or print data in the memory 600. An operation unit 150, which is connected with the control device 110, provides a user interface (I/F). The user I/F includes a liquid crystal touch panel as the main component thereof, and is used to operate the image processing system.

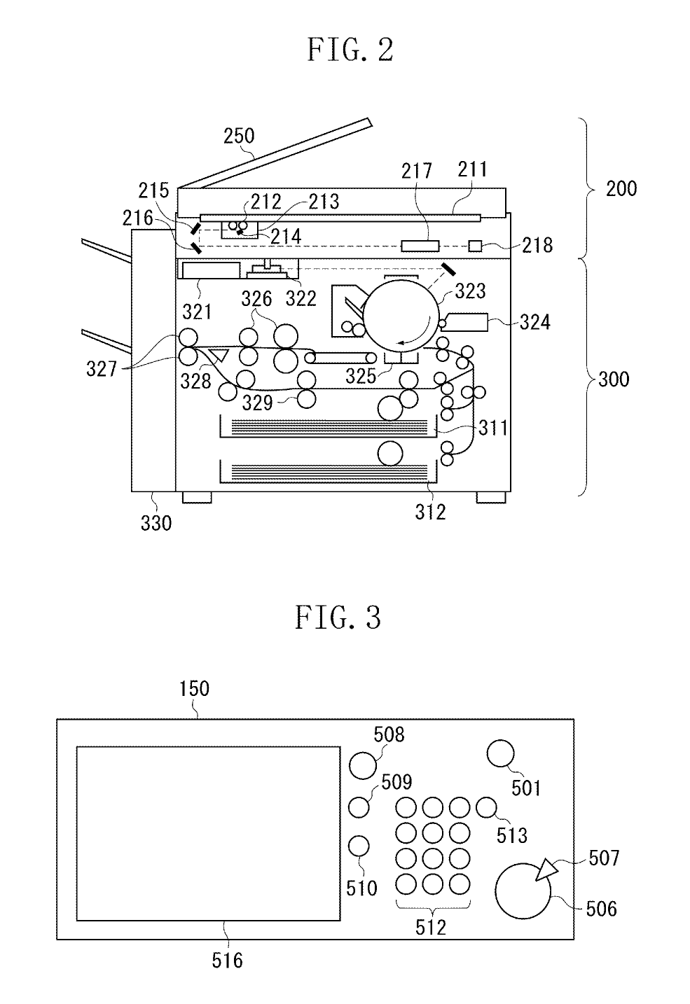

FIG. 2 illustrates an example of a cross-section of the reader unit 200 and printer unit 300. The document feeding unit 250 in the reader unit 200 sequentially feeds documents onto a platen glass 211 one by one from the top of the documents. After each document is read, the document feeding unit 250 discharges the document on the platen glass 211. When a document is conveyed onto the platen glass 211, a lamp 212 turns on, and an optical unit 213 starts moving to subject the document to exposure scanning.

The light reflected from the document during the scanning is guided to a charge coupled device (CCD) image sensor (hereinafter referred to as a “CCD”) 218 by mirrors 214, 215, and 216 and a lens 217. The CCD 218 reads the image of the scanned document in this way. The image data output from the CCD 218 is subjected to predetermined processing and then transmitted to the control device 110. In the control device 110, the image data is rendered electronically as a bitmap image.

A laser driver 321 in the printer unit 300 drives a laser emitting unit 322 to cause the laser emitting unit 322 to emit laser light corresponding to the image bitmap data output from the control device 110. The laser light is applied to a photosensitive drum 323 to form a latent image corresponding to the laser light on the photosensitive drum 323. A development unit 324 applies a developer to the latent image on the photosensitive drum 323.

Simultaneously with the timing of the start of the laser light application, a recording sheet is fed from either a cassette 311 or 312 and conveyed to a transfer unit 325. In the transfer unit 325, the developer applied to the photosensitive drum 323 is transferred to the recording sheet. The recording sheet with the developer thereon is conveyed to a fixing unit 326. The fixing unit 326 applies heat and pressure to fix the developer onto the recording sheet. After passing through the fixing unit 326, the recording sheet is discharged by a discharge roller 327 to the sheet discharge unit 330.

For two-sided recording, after the recording sheet is conveyed to the discharge roller 327, the direction of rotation of the discharge roller 327 is reversed, so that a flapper 328 guides the recording sheet to a re-feed conveyance path 329. The recording sheet guided to the re-feed conveyance path 329 is fed to the transfer unit 325 at the above-mentioned timing.

FIG. 3 illustrates an example of an operation unit 150 of a copying apparatus. When a user presses a power switch 501, a touch panel 516 is turned on, allowing the user to perform operations to use the scan, print, and copy functions. When the user presses the power switch 501 again, the touch panel 516 is turned off to go into the power saving mode.

The user can use a numeric keypad 512 to input numerical values for setting the number of images to be formed and for setting the mode. The user can use a clear key 513 to nullify settings input from the numeric keypad 512. The user can use a reset key 508 to reset settings made for the number of images to be formed, the operation mode, and other modes, such as the selected paper feed stage, to their default values. The user can press a start key 506 to commence image formation, such as scanning and copying. The user can use a stop key 507 to stop the image formation operation.

The user can press a guide key 509 when the user wants to know a predetermined key function. In response to the pressed guide key 509, the image forming apparatus displays on the touch panel 516 an explanation of the function that the user wants to know. The user can use a user mode key 510 to change settings on the image forming apparatus, for example, the setting as to whether to produce sound when the user presses the touch panel 516.

For each of the scan, print, and copy functions, a setting screen is displayed on the touch panel 516. The user can make specific settings by touching rendered keys. For example, for scanning, the user can make settings for the file format of scanned-in image and the destination to which the scanned-in image is to be sent via the network.

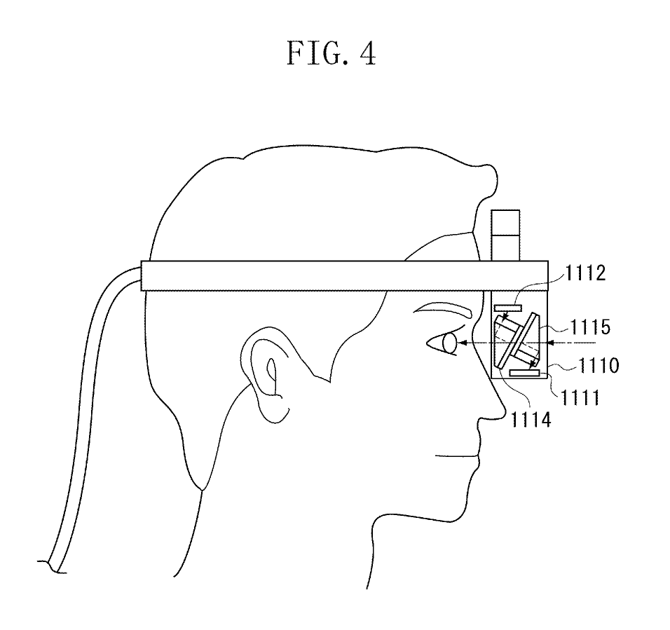

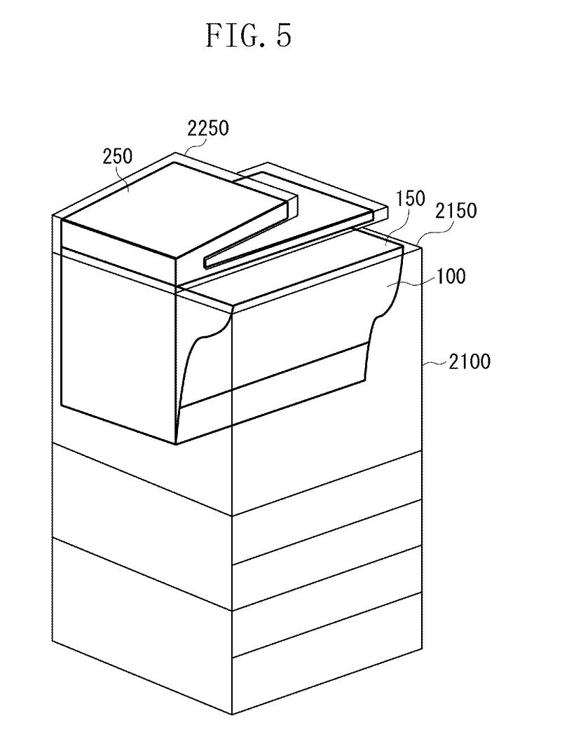

A head mounted display (HMD) as an example of a display apparatus will be described. FIG. 4 schematically illustrates an example of the structure of the HMD 1110. The HMD 1110 includes a video camera 1111 as an example of an imaging unit, a liquid crystal display (LCD) 1112, and optical prisms 1114 and 1115. The HMD 1110 connected with the server 401 superimposes a video image received from the server 401 on a video image captured by the video camera 1111 to display the superimposed image.

The video camera 1111 captures an image of light guided by the optical prism 1115. As a result, an image of a real space as seen according to the position and orientation of the user's viewpoint is captured. In the present exemplary embodiment, the HMD 1110 includes a single video camera 1111. However, the number of video cameras 1111 is not limited to this. Two video cameras 1111 may be provided to capture real space video images as seen according to the respective positions and orientations of the user's right and left eyes. The captured video image signal is output to the server 401.

The LCD 1112 receives a video image signal generated and output by the server 401, and displays a video image based on the received video image signal. In the present exemplary embodiment, the image forming apparatus in the real space illustrated in FIGS. 1 and 2 forms an image on a paper medium in a real space captured by the video camera 1111. A video image sent from the server 401 is superimposed on the image of the image forming apparatus in the real space. The LCD 1112 displays a resultant superimposed video image (a video image in a mixed reality space). The optical prism 1114 guides the displayed video image to the user's pupils. The video camera 1111 is an example of an imaging unit.

FIG. 5 illustrates an example of a video image obtained by superimposing, on the image forming apparatus 100 in the real space, a video image of another image forming apparatus 2100.

The function of the server 401 will be described below. The server 401 detects a user's action from a real space video image input from the HMD 1110 by using a motion capture function utilizing the video image. To be specific, the HMD 1110 displays an image of an operation unit 2150 of the other image forming apparatus 2100 at the position of the operation unit 150 of the image forming apparatus 100 in the real space.

When detecting, based on the image captured by the HMD 1110, the operator's action of operating the operation unit 2150, the server 401 can provide the operator with the function of the other image forming apparatus 2100 as if the operator operated the operation unit 2150 of the other image forming apparatus 2100. In displaying the image, the HMD 1110 aligns the plan position of the operation unit 150 and that of the operation unit 2150 of the other image forming apparatus 2100.

For example, vector scan, which will be described below, is a function that the image forming apparatus 100 does not have, but the other image forming apparatus 2100 has. By operating the operation unit 2150, the operator can cause the server 401 to provide a vector scan function.

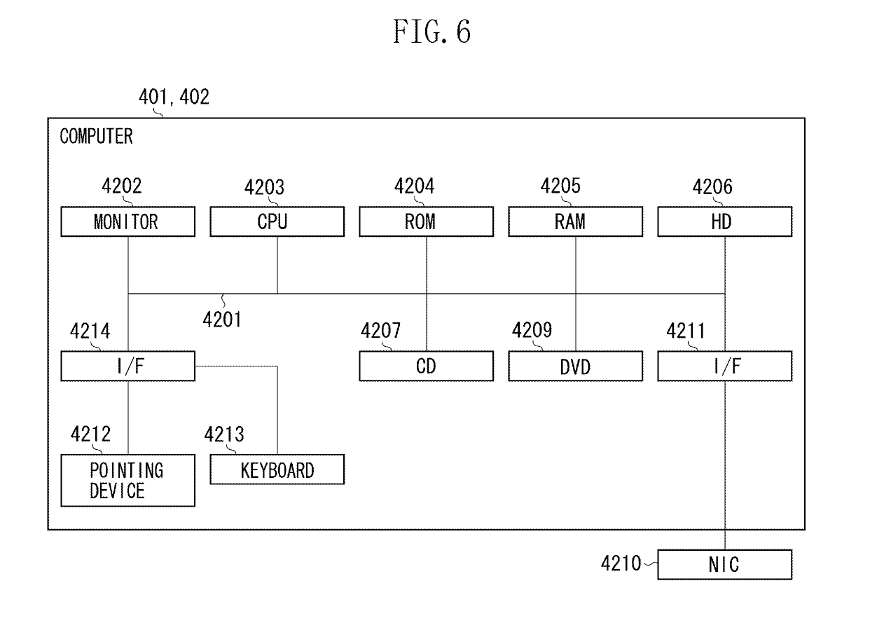

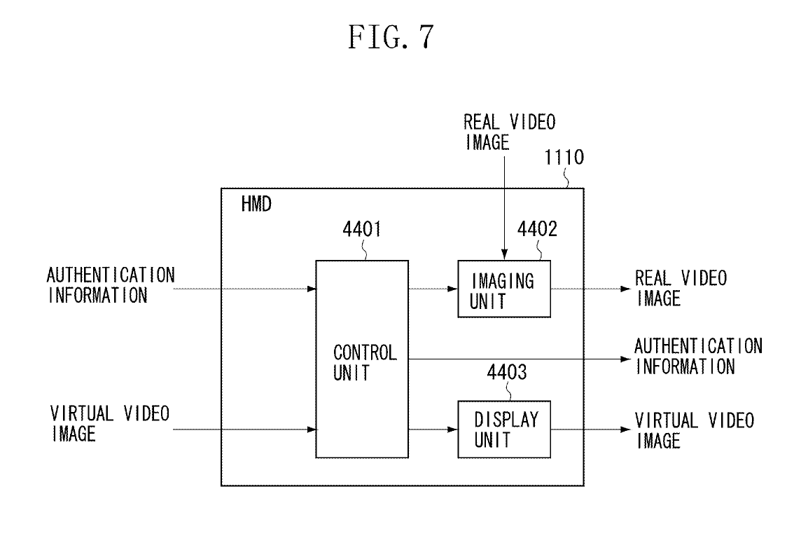

With reference to FIG. 6, a computer will be described. FIG. 6 illustrates an example of the hardware configuration of the host computer functioning as the server 401 or the PC 402.

In FIG. 6, the server 401 or the PC 402 is a commonly used personal computer, for example. The server 401 or the PC 402 can store data on a hard disk (HD) 4206, a compact disc read-only memory (CD-ROM) drive (CD) 4207, and a digital versatile disc (DVD) 4209, for example, and can display image data, for example, stored in the HD 4206, the CD-ROM drive (CD) 4207, or the DVD 4209 on a monitor 4202. Furthermore, the server 401 or the PC 402 can distribute image data, for example, via the Internet by using a network information card (NIC) 4210, for example.

Various types of instructions, for example, from a user are input from a pointing device 4212 and a keyboard 4213. In the server 401 and the PC 402, a bus 4201 connects blocks, which will be described below, allowing the sending and receiving of various types of data.

The monitor 4202 displays various types of information from the server 401 and the PC 402. A CPU 4203 controls the operations of members in the server 401 and PC 402, and executes programs loaded into a random access memory (RAM) 4205. A read only memory (ROM) 4204 stores a basic input-output system (BIOS) and a boot program. For later processing in the CPU 4203, the RAM 4205 temporarily stores programs, and image data to be processed. An operating system (OS), and programs necessary for the CPU 4203 to perform various types of processing (to be described below) are loaded into the RAM 4205.

The hard disk (HD) 4206 is used to store the OS and programs transferred to the RAM 4205, for example, and to store and read image data during an operation of the apparatus. The CD-ROM drive 4207 reads data stored in, and writes data onto, a CD-ROM (a compact disc-recordable (CD-R), a compact disc-rewritable (CD-R/W), etc.), which is an external storage medium.

The DVD-ROM (DVD-RAM) drive 4209, like the CD-ROM drive 4207, can read data from a DVD-ROM and write data into a DVD-RAM. In the case of programs for image processing stored in a CD-ROM, FD, DVD-ROM, or other storage media, the programs are installed on the HD 4206, and transferred to the RAM 4205 as necessary.

An interface (I/F) 4211 connects the server 401 and the PC 402 with the network interface card (NIC) 4210 that establishes connection with a network such as the Internet. The server 401 and the PC 402 send data to, and receive data from, the Internet via the I/F 4211. An I/F 4214 connects the pointing device 4212 and the keyboard 4213 to the server 401 and the PC 402. Various instructions input from the pointing device 4212 and the keyboard 4213 via the I/F 4214 are input to the CPU 4203.

FIG. 7 illustrates an example of the hardware configuration of the HMD 1110. As illustrated in FIG. 7, the HMD 1110 includes a control unit 4401, an imaging unit 4402, and a display unit 4403. The control unit 4401 provides the function of controlling processing according to input information.

When a user first wears the HMD 1110, that is, when virtual space information has not yet been input from the server 401, the control unit 4401 determines that authentication has not yet been performed, and thus performs user authentication. In the present exemplary embodiment, authentication information is a password. However, the HMD 1110 may additionally include a fingerprint sensor, for example, to obtain fingerprints.

The control unit 4401 controls the processing for capturing a real video image in the imaging unit 4402. An image captured by the imaging unit 4402 is transmitted to the server 401. The server 401 acquires authentication information about the user and the password by using a motion capture function, for example, by capturing the user's action of seeing and pressing information of randomly arranged characters displayed as virtual information. The server 401 performs user authentication using the acquired authentication information. Then, in the present exemplary embodiment, the server 401 performs authentication to determine, for example, whether the user who has passed the user authentication can use the functions of the image forming apparatus 2100.

The imaging unit 4402, which is the video camera 1111 illustrated in FIG. 4, acquires real video images. As set forth above, the control unit 4401 outputs the real video images acquired by the imaging unit 4402 to the server 401.

Furthermore, when the control unit 4401 receives a virtual video image, the control unit 4401 transfers the virtual video image to the display unit 4403. The display unit 4403 displays the received virtual video image to the user. While the display unit 4403 displays the virtual video image to the user, real video images are captured and constantly output to the server 401.

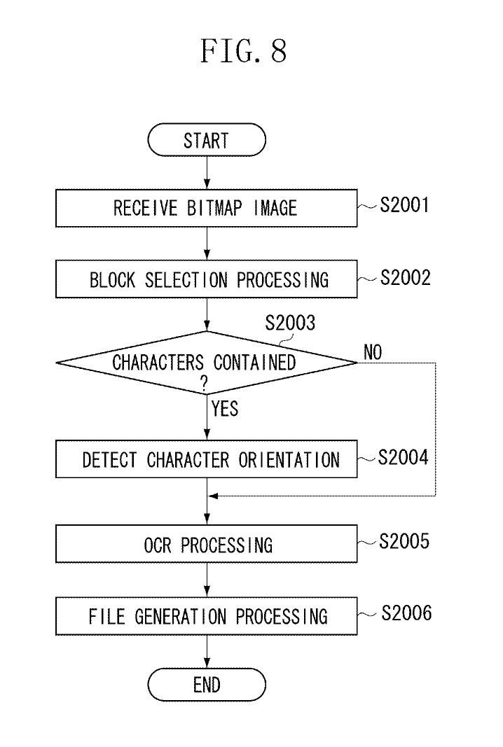

FIG. 8 is a flowchart illustrating an example of vectorization processing. The scanner unit 210 scans a document and transmits the obtained data to the control device 110. The control device 110 forms a bitmap image based on the received data.

If a file is formed from this bitmap image without alteration, characters, if any, contained in the image will not be recognized as characters, making character search impossible and thus resulting in inconvenience. Therefore, a vectorization function is performed as follows. Block selection is performed to obtain character regions in the bitmap image, and characters are recognized and converted into character codes.

In the present exemplary embodiment, the server 401 performs vectorization processing. Specifically, a bitmap image formed in the image forming apparatus 100 is transmitted to the server 401. The server 401 performs vectorization processing on the bitmap image, and then sends a file obtained after the vectorization processing to the image forming apparatus 100.

In step S2001, the server 401 receives a bitmap image via the network 400.

In step S2002, the server 401 performs block selection processing on the received bitmap image.

The server 401 first binarizes the input image to generate a monochrome image, and performs contour tracing to extract pixel blocks that are surrounded by contours made up of black pixels. For black-pixel blocks having a large area, the server 401 further traces contours made up of white pixels present in those large-area black-pixel blocks, thereby extracting white-pixel blocks. Furthermore, the server 401 recursively extracts black-pixel blocks from the inside of white-pixel blocks whose area is equal to or larger than a predetermined size.

The server 401 classifies the black-pixel blocks obtained in this manner into regions of different attributes according to size and shape. The server 401 recognizes blocks having an aspect ratio of approximately 1 and a size within a predetermined range as pixel blocks corresponding to characters, and then recognizes areas in which adjacent characters are neatly aligned to form a group, as character regions.

In step S2003, if the server 401 recognizes that the image contains characters (YES in step S2003), the process branches to step S2004. If the server 401 recognizes that the image contains no characters (NO in step S2003), the process branches to step S2006.

When recognizing characters in a character region extracted in the block selection processing in step S2002, the server 401 first determines whether the characters in that region are written vertically or horizontally. Then, the server 401 cuts out lines in the corresponding direction, and then cuts out the characters to thereby obtain character images.

In step S2004, for the determination of the vertical or horizontal writing, the server 401 obtains horizontal and vertical projections of pixel values in the region. If the dispersion of the horizontal projection is larger, the server 401 determines that the characters in the region are written horizontally. If the dispersion of the vertical projection is larger, the server 401 determines that the characters in the region are written vertically.

The server 401 cuts out the character string and then the characters as follows. For horizontal writing, the server 401 cuts out lines using the projection in the horizontal direction, and then cuts out the characters from the projection in the vertical direction with respect to the cut-out lines. For character regions with vertical writing, the server 401 may perform the above-described processing with the horizontal and vertical directions interchanged.

If the server 401 recognizes that the image contains characters (YES in step S2003), then in step S2005, the server 401 performs OCR processing. In this processing, the server 401 recognizes each image, cut out character by character, using a pattern matching technique to obtain a corresponding character code.

In this recognition processing, the server 401 compares an observed feature vector, which is a numeric string of several tens of dimensions converted from a feature extracted from the character image, with dictionary feature vectors calculated beforehand for the respective character types. The character type whose vector is closest to the observed feature vector is determined as the recognition result.

There are various well-known techniques for extracting feature vectors. For example, according to one such technique, a character is segmented into meshes, and character lines in each mesh are counted as line elements in the respective directions to thereby obtain, as a feature, a vector having dimensions corresponding to the number of meshes.

In step S2006, finally, if the server 401 detects a character string, the server 401 generates a file, for example, in PDF format together with the character code string and the coordinates of the image. The server 401 then ends the processing illustrated in FIG. 8.

The character coding has been described as the vectorization processing in the present exemplary embodiment. Alternatively, a graphic outline processing, for example, may also be employed. In the graphic outline processing, graphics in a bitmap are recognized, and the outlines of the graphics are converted into electronic data, so that each graphic is in such a form as to be electronically reusable later.

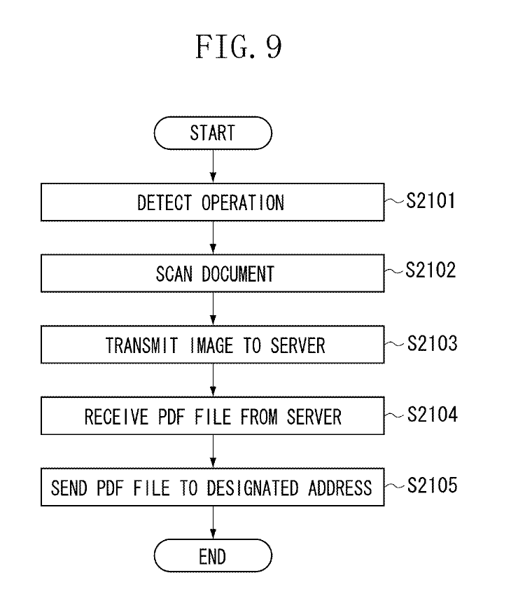

FIG. 9 is a flowchart illustrating an example of processing for providing a vector scan function in which the vectorization processing illustrated in FIG. 8 is used.

First, when an operator wears the HMD 1110, a video image (image), obtained by superimposing a video image of the other image forming apparatus 2100 on the image forming apparatus 100 in the real space, is displayed as illustrated in FIG. 5. Also, as described previously, the server 401 detects the operator's action of operating the operation unit 2150, based on a captured image from the HMD 1110. The server 401, for example, can provide the operator with the function of the other image forming apparatus 2100 as if the operator operated the operation unit 2150 of the other image forming apparatus 2100.

For example, a “vector scan” button is displayed on the operation unit 2150. The operation unit 2150 also displays a list of addresses, for example, “e-mail addresses” to which the image forming apparatus 100 may send a file via the network 400 after scanning. The operator selects from the list an “e-mail address” to which the operator wants to send the file, and presses a scan start button, i.e., the “vector scan” button in the present exemplary embodiment. This allows the operator to send the scanned-in and processed file to the selected “e-mail address”.

In step S2101, the server 401 detects the operator's operation in which the operator has touched the column of a specific “e-mail address” in response to the display of the “e-mail address” list on the operation unit 2150, and then pressed the “vector scan” button in response to the display of the “vector scan” button on the operation unit 2150. The server 401 notifies the image forming apparatus 100 of the detection result.

In step S2102, in response to the notification, the image forming apparatus 100 scans a document set in the document feeding unit 250 to convert the document into a bitmap image.

The image forming apparatus 100 transmits the bitmap image to the server 401, and requests the server 401 to perform vectorization processing on the bitmap image. That is, since the image forming apparatus 100 does not have a vectorization processing function, the image forming apparatus 100 requests the server 401 to perform vectorization processing. In step S2103, the server 401 performs the vectorization processing as illustrated in FIG. 8.

In step S2104, from the server 401 that has performed the vectorization processing as illustrated in FIG. 8, the image forming apparatus 100 receives a PDF file obtained after the processing.

In step S2105, the image forming apparatus 100 sends the PDF file received in step S2104 to the e-mail address in the “e-mail address” list pressed on the operation unit 2150 in step S2101.

Thus, the operator can use, on the image forming apparatus 100, the vector scan function of the image forming apparatus 2100 as if the operator used the image forming apparatus 2100. The image forming apparatus 2100 and the image forming apparatus 100 are superimposed to display the superimposed image. The operation unit 2150 of the image forming apparatus 2100 is displayed at the position of the operation unit 150 of the image forming apparatus 100. The document feeding unit 2250 of the image forming apparatus 2100 is displayed at the position of the document feeding unit 250 of the image forming apparatus 100. Accordingly, the operator of the image forming apparatus 100 can use the vector scan function of the image forming apparatus 2100 with realism as if the operator used the image forming apparatus 2100.

When an application in the PC 402 requests the image forming apparatus 100 to perform printing, a printer driver for the application in the PC 402 transmits a PDL, which is a printer language interpretable by the control device 110 in the image forming apparatus 100, on a job-by-job basis. The term “job” as used herein means a unit for instructing a single printing operation (e.g., two-sided printing) for printing a single file on a single application.

The control device 110 of the image forming apparatus 100 interprets the PDL job received from the PC 402, rasterizes the interpreted job as a bitmap image to the memory 600, prints the image by a printing unit 320, and discharges the printed sheet into the sheet discharge unit 330.

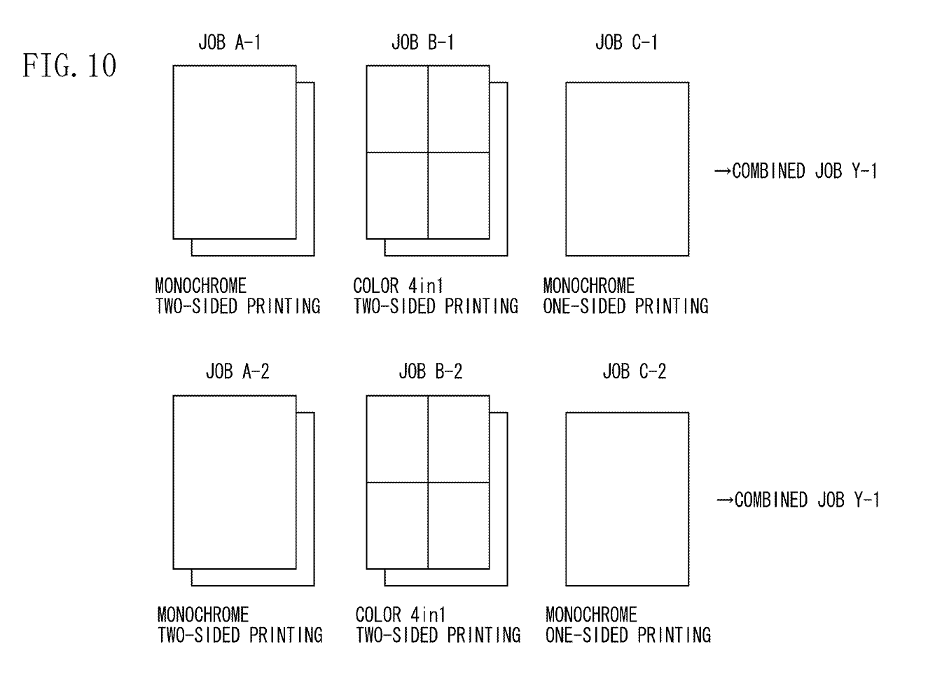

Referring to FIG. 10, job-combining printing will be described. FIG. 10 illustrates an example of job-combining printing. As mentioned above, a job is a unit for instructing a single printing operation for printing a single file on a single application.

For example, in FIG. 10, monochrome two-sided printing of a file is performed on an application (job A-1), and then color 4in1 two-sided printing of a file is performed on an application (job B-1). Then, monochrome one-sided printing of a file without layout reduction is performed on an application (job C-1). These applications may be the same or different. These files may be the same or different. In all these cases, to print each job from the application, the user needs to open the printer driver from the application to start printing.

Suppose a case in which these jobs A-1, B-1, and C-1 are a set of documents used in a meeting, for example, and that the user needs to provide the required number of copies of the documents printed in units of this document set as the meeting material, for example. In a conventional method, when two copies of this document set are needed, the user opens the printer driver and instructs printing to initiate the jobs A-1, B-1, and C-1. Then, the user needs to perform the same procedure, i.e., opening the printer driver and instructing printing to initiate the jobs A-2, B-2, and C-2. As the number of copies to be printed is increased, the task becomes more burdensome.

In this case, “job-combining” means combining the jobs A-1, B-1, and C-1 into a combined job Y-1, and printing of the required number of copies, for example, two copies, of the combined job Y-1 is instructed. This eliminates the need for the burdensome task of instructing a printing operation for each job.

The memory 600 in the image forming apparatus 100 in the present exemplary embodiment has limitations, and cannot perform such a job-combining function on print jobs received from the PC 402. The server 401, however, has a job-combining function.

To be specific, print jobs received from the PC 402 are transferred to the server 401, and the HMD 1110 superimposes a video image of the other image forming apparatus 2100 on the image forming apparatus 100 in the real space. From the operation unit 2150 of the other image forming apparatus 2100, the operator can instruct the server 401 to combine the jobs A-1, B-1, and C-1 into the combined-job Y-1, and can print the number of copies desired. Since the actual other image forming apparatus 2100 has the job-combining function, the operator can use the job-combining function of the other image forming apparatus 2100 by using the image forming apparatus 100.

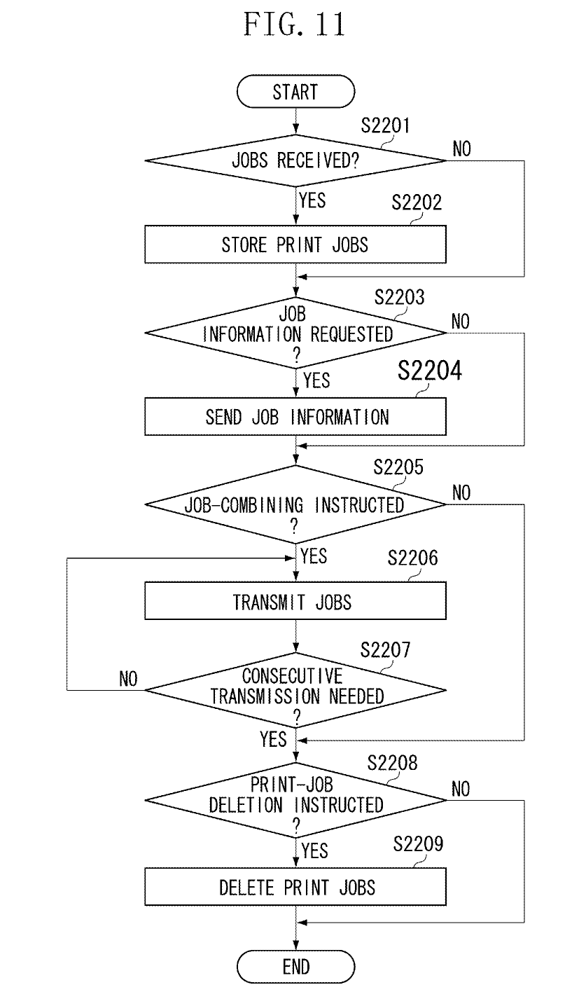

FIG. 11 is a flowchart illustrating an example of processing in the server 401 performed to provide the print-job-combining function. In step S2201, the image forming apparatus 100 and then the server 401 receive, via the network 400, print jobs issued from a printer driver for an application in the PC 402. If the server 401 receives the print jobs (YES in step S2201), then in step S2202, the server 401 stores jobs containing a PDL in the hard disk.

If the server 401 receives a request for print job information from the image forming apparatus 100 (YES in step S2203), then in step S2204, the server 401 sends the information on the jobs stored in step S2202, for example, the file names of the jobs, to the image forming apparatus 100.

If the server 401 receives an instruction that, of the jobs in the job information sent instep S2204, two or more jobs selected by the image forming apparatus 100 should be combined (YES in step S2205), the server 401 causes the process to proceed to step S2206.

In step S2206, if the jobs to be combined are, for example, the jobs A-1, B-1, and C-1, then the server 401 transmits the jobs A-1, B-1, and C-1 in this order to the image forming apparatus 100 as if the jobs A-1, B-1, and C-1 are a combined continuous job.

In step S2207, if the job-combining instruction provided in step S2205 specifies the number of copies to be printed, for example, two copies, the server 401 repeats the step S2206 for the number of times equal to the number of copies to be printed.

If there is an instruction from the image forming apparatus 100 to delete a job (YES instep S2208), then instep S2209, the server 401 deletes the corresponding job in the server 401.

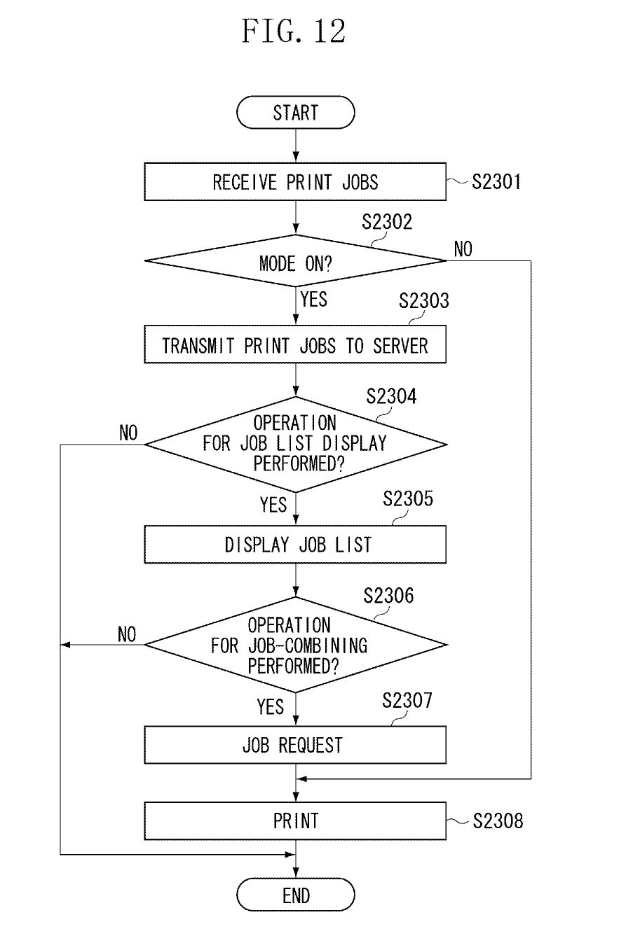

FIG. 12 is a flowchart illustrating an example of processing in the image forming apparatus 100 and the server 401 performed to provide the print-job-combining function.

If the operator wears the HMD 1110, the HMD 1110 displays a video image, obtained by superimposing a video image of the other image forming apparatus 2100 on the image forming apparatus 100 in the real space, as illustrated in FIG. 5. As described above, the operator's action of operating the operation unit 2150 is detected, and the function of the other image forming apparatus 2100 can be provided as if the operator operated the operation unit 2150 of the other image forming apparatus 2100. This mode can be enabled or disabled using the user mode key 510 illustrated in FIG. 3.

In step S2301, the image forming apparatus 100 receives print jobs from the PC 402. In step S2302, the image forming apparatus 100 determines whether the mode mentioned above is enabled. If the mode is disabled (NO in step S2302), then in step S2308, the image forming apparatus 100 performs printing for each job, and ends the processing illustrated in FIG. 12. If enabled (YES in step S2302), then in step S2303, the image forming apparatus 100 transmits the received print jobs to the server 401.

In step S2304, the server 401 determines, based on a captured image from the HMD 1110, whether the user has performed on the operation unit 2150 an action (operation) for displaying a job list. If the user has performed the action (YES in step S2304), the server 401 transmits the list of jobs stored in the server 401 to the image forming apparatus 100 as illustrated in FIG. 11. The image forming apparatus 100 displays the series of jobs on the operation unit 2150. In step S2305, the image forming apparatus 100 displays the file names of the print jobs, for example, “A-1”, “B-1”, and “C-1”, input from the PC 402 to the image forming apparatus 100 and then transmitted to the server 401.

In step S2306, based on the captured image from the HMD 1110, the server 401 determines whether the operator has performed, on the operation unit 2150, the operation of selecting the jobs to be combined from the displayed job list and providing an instruction to combine the selected jobs. For example, in step S2305, the job names, such as “A-1”, “B-1”, and “C-1”, are displayed, and the operator selects those job names. The operator then inputs, for example, “three copies” in response to the display of “the number of copies to be printed” on the operation unit 2150, and presses “job-combining print”. As a result, in steps S2307 and S2308, the job-combining and the printing are performed.

In step S2307, the server 401 sequentially invokes the stored jobs “A-1”, “B-1”, and “C-1” to transmit those jobs in that order to the image forming apparatus 100 as if the jobs “A-1”, “B-1”, and “C-1” are a continuously combined job.

In step S2308, the image forming apparatus 100 performs printing sequentially in response to the received jobs. For example, if “three copies” is designated in step S2306, the server 401 invokes the jobs “A-1”, “B-1”, and “C-1” and repeats the sequential printing thereof for a total of three times. That is, the jobs “A-1”, “B-1”, and “C-1” are combined into a single job, and three copies of the combined job are printed.

Thus, the operator can use, on the image forming apparatus 100, the job-combining printing function of the image forming apparatus 2100 as if the operator used the image forming apparatus 2100. The image forming apparatus 2100 is superimposed and displayed on the image forming apparatus 100. The operation unit 2150 of the image forming apparatus 2100 is displayed at the position of the operation unit 150 of the image forming apparatus 100. Accordingly, the operator can use the job-combining printing function of the image forming apparatus 2100 with realism as if the operator operated the image forming apparatus 2100.

The present invention may also be implemented by performing the following processing. Software (programs) for implementing the functions of the exemplary embodiments described above is provided to a system or an apparatus via a network or various storage media. Then, a computer (or a central processing unit (CPU) or a micro processing unit (MPU), for example) in that system or apparatus reads and executes those programs.

According to the exemplary embodiments described above, there is provided a technique in which a user can, by looking at an apparatus actually being used by the user through a display apparatus, cause another apparatus to be virtually displayed, and an operation performed by the user on the virtually displayed other apparatus is detected to invoke the function of the other apparatus desired by the user.

In the foregoing exemplary embodiments, an HMD is described as an example of a display apparatus. Alternatively, a display apparatus in the form of a portable terminal that includes a display unit and an imaging unit may also be employed. The display unit may be of either the transmissive or non-transmissive type.

In an example provided in the foregoing exemplary embodiments, the server 401 detects, e.g., an operator's operation (action). However, the HMD 1110 may detect, e.g., an operator's operation (action), based on an image captured by the HMD 1110, and notify the server 402 of the detection result.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-149970 filed Jun. 30, 2010, which is hereby incorporated by reference herein in its entirety.

What is claimed is:

1. An information processing system comprising an information processing apparatus and a display apparatus including an imaging unit,
wherein the display apparatus superimposes an image of a first processing apparatus not having a predetermined function, captured by the imaging unit, and an image of a second processing apparatus having the predetermined function to display the superimposed image, and sends an image captured by the imaging unit to the information processing apparatus; and
wherein the information processing apparatus performs processing for providing the predetermined function, when detecting, from the captured image received from the display apparatus, that a user of the first processing apparatus has performed an operation for using the predetermined function.

2. The information processing system according to claim 1, wherein the first and second processing apparatuses are image processing apparatuses; and
wherein the predetermined function is a function relating to scanning or printing.

3. The information processing system according to claim 1, wherein the display apparatus receives the image of the second processing apparatus having the predetermined function from the second information processing apparatus, and superimposes the image of the first processing apparatus not having the predetermined function, captured by the imaging unit, and the image of the second processing apparatus having the predetermined function to display the superimposed image.

4. An information processing apparatus capable of communicating with a display apparatus including an imaging unit via a network,
wherein the information processing apparatus receives an image captured by the imaging unit from the display apparatus, and when detecting, from the received image, that a user of a first processing apparatus not having a predetermined function has performed an operation for using the predetermined function on an image of a second processing apparatus having the predetermined function, superimposed and displayed on an image of the first processing apparatus, performs processing for providing the predetermined function.

5. An information processing apparatus comprising:
an imaging unit configured to capture an image of a first apparatus not having a predetermined function;
a display unit configured to superimpose the image of the first apparatus captured by the imaging unit and an image containing an operation unit of a second apparatus having the predetermined function to display the superimposed image;
a detection unit configured to detect an instruction to perform the predetermined function, provided on the operation unit;
a request unit configured to request, when the detection unit detects the instruction to perform the predetermined function, a third apparatus capable of performing the predetermined function to perform the predetermined function; and
a reception unit configured to receive a result obtained by performing the predetermined function from the third apparatus.

6. The information processing apparatus according to claim 5, further comprising a transfer unit configured to transfer the received result of the performed predetermined function to the first apparatus.

7. An information processing method in an information processing system including an information processing apparatus and a display apparatus including an imaging unit, the method comprising:
via the display apparatus, superimposing an image of a first processing apparatus not having a predetermined function, captured by the imaging unit, and an image of a second processing apparatus having the predetermined function to display the superimposed image, and sending an image captured by the imaging unit to the information processing apparatus; and
via the information processing apparatus, performing processing for providing the predetermined function when detecting, from the captured image received from the display apparatus, that a user of the first processing apparatus has performed an operation for using the predetermined function.

8. An information processing method performed by an information processing apparatus capable of communicating with a display apparatus including an imaging unit via a network, the method comprising:
receiving an image captured by the imaging unit from the display apparatus; and
when detecting, from the received image, that a user of a first processing apparatus not having a predetermined function has performed an operation for using the predetermined function on an image of a second processing apparatus having the predetermined function, superimposed and displayed on an image of the first processing apparatus, performing processing for providing the predetermined function.

9. An information processing method comprising:
capturing an image of a first apparatus not having a predetermined function;
superimposing the captured image of the first apparatus and an image containing an operation unit of a second apparatus having the predetermined function to display the superimposed image;
detecting an instruction to perform the predetermined function, provided on the operation unit;
requesting, when detecting the instruction to perform the predetermined function, a third apparatus capable of performing the predetermined function to perform the predetermined function; and
receiving a result obtained by performing the predetermined function from the third apparatus.

10. A storage medium storing a program for causing a computer capable of communicating with a display apparatus including an imaging unit via a network to perform a method comprising:
receiving an image captured by the imaging unit from the display apparatus; and
when detecting, from the received image, that a user of a first processing apparatus not having a predetermined function has performed an operation for using the predetermined function on an image of a second processing apparatus having the predetermined function, superimposed and displayed on an image of the first processing apparatus, performing processing for providing the predetermined function.

11. A storage medium storing a program for causing a computer to perform a method comprising:
capturing an image of a first apparatus not having a predetermined function;
superimposing the captured image of the first apparatus and an image containing an operation unit of a second apparatus having the predetermined function to display the superimposed image;
detecting an instruction to perform the predetermined function, provided on the operation unit;
requesting, when detecting the instruction to perform the predetermined function, a third apparatus capable of performing the predetermined function to perform the predetermined function; and
receiving a result obtained by performing the predetermined function from the third apparatus.
